(19) United States
(12) Patent Application Publication
(10) Pub. No.: US 2008/0195488 A1
(43) Pub. Date: Aug. 14, 2008

(54) Systems and Methods for Progressive Discounting

(76) Inventor: Amit Orgad, Duluth, GA (US)

Correspondence Address: MALAS LAW, LLC, 400 PERIMETER CENTER TERRACE, NE, SUITE 900, ATLANTA, GA, 30346, US

(21) Appl. No.: 12/028,330

(22) Filed: Feb. 8, 2008

Related U.S. Application Data
(60) Provisional application No. 60/888,907, filed on Feb. 8, 2007.
(60) Provisional application No. 60/888,910, filed on Feb. 8, 2007.

(51) Int. Cl. G06Q 30/00

(52) U.S. Cl. 705/14

(57) ABSTRACT

A method for progressive discounting includes charging fee amounts to respective customers at different respective times, progressively reducing a price of at least one item based on each of the fee amounts, providing each of the customers with access to information identifying a current progressively reduced price for the item, and selling the item to one of the customers at a current progressively reduced price.

### CROSS-REFERENCE

This application claims priority to U.S. Provisional Patent Application No. 60888907 titled “Membership Based Progressive Discount Product Sales System & Method of Use Thereof” filed on Feb. 8, 2007, which is hereby incorporated by reference in its entirety. This application also claims priority to U.S. Provisional Patent Application No. 60888910 titled “Clustered or Grouped Regular & Reverse Auction System” filed on Feb. 8, 2007, which is hereby incorporated by reference in its entirety.

### BACKGROUND

The national economy and the standard of living depends in part consumer demand for products and services. There are many existing marketing schemes for increasing consumer demand. For example, some merchants discount select products on certain holidays to attract shoppers. Other merchants and/or service providers offer incentives such as “free” products to their customers. However, existing marketing schemes are sometimes not enough to maintain consumer demand at a desired level. Furthermore, existing marketing schemes often fail to generate sufficient sales and revenues for companies.

### SUMMARY

Systems and methods for progressive discounting are disclosed. An embodiment of a method for progressive discounting includes charging fee amounts to respective customers at different respective times, progressively reducing a price of at least one item based on each of the fee amounts, providing each of the customers with access to information identifying a current progressively reduced price for the item, and selling the item to one of the customers at a current progressively reduced price.

Other systems, methods, features, and advantages of the present systems and methods will be or become apparent to one with skill in the art upon examination of the following drawings and detailed description. It is intended that all such additional systems, methods, features, advantages, and be included within the scope of this disclosure.

### BRIEF DESCRIPTION OF THE DRAWINGS

The present systems and methods can be better understood with reference to the following figures. The components within the figures are not necessarily to scale, emphasis instead being placed upon clearly illustrating principles associated with progressive discounting. Moreover, in the figures, like reference numerals designate corresponding parts throughout the different views.

FIG. 1 is a block diagrams illustrating a communication system in accordance with exemplary embodiments.

FIG. 2 is a flowchart illustrating a method for progressive discounting in accordance with exemplary embodiments.

FIG. 3 is a block diagram illustrating a customer device in accordance with exemplary embodiments.

FIG. 4 is a block diagram illustrating a discounting system in accordance with exemplary embodiments.

### DETAILED DESCRIPTION

According to exemplary embodiments, products and/or services (“products/services”) are progressively discounted responsive to shopping fees paid by customers. As more shopping fees are paid by customers, one or more products are further discounted. A shopping fee may comprise and/or may be labeled as, for example, an entry fee, a membership fee, a sale fee, an information access fee, and/or a product access fee. Each charged shopping fee may provide a corresponding customer with access to one or more products/services, groups of products/services, and/or product/service discount information, depending on a desired implementation.

Product/service related information that may be made available prior to a fee payment may include, for example, a product/service type, a name brand, a product/service description, a starting price, and/or an MSRP (manufacturer suggested retail price). A starting price may be set equal to or different from the MSRP, depending on a desired implementation. After a customer pays a required fee in connection with a product, the customer is provided with access to the product's current discount information (e.g., discounted price, discount amount, discount rate, and/or discount percentage).

The progressively discounted products/services may be sold at physical locations that are visited by customers and/or via remote communications. Such physical shopping locations may include, for example, stores, malls, shopping centers, shopping plazas, parks, and/or parking lots. The products/services may additionally or alternatively be purchased from remote locations. Each product/service may be purchased via one or more sales channels. For example, a particular product/service may be purchased at the physical location of the product/service and/or remotely. A fee charged in connection with the particular product/service may either be dependent on or independent of whether the product/service is to be purchased on-location or remotely.

Products may be grouped in shopping areas such as rooms or store sections. Information about a group of products may be displayed on signs or display devices near or outside where the group of products is located. Information indicating a progressively discounted price or discount rate may be concealed from customers that have not paid the required fee in connection with the corresponding product or group of products.

Product-related information that may be provided without fee payment may include, for example, a product type, a product brand, a description of the product, and/or a product's suggested retail price. Other information that may be provided without fee payment includes available value added content and promotions offered in connection with a corresponding product. Discount information (e.g., discounted price, discount amount, discount rate, and/or discount percentage) related to a product or a group of products may be provided after a corresponding fee is paid by a customer.

According to exemplary embodiments, payment of a shopping fee may entitle a customer to value added content or features. A customer may view, use, and/or participate in product-related value added feature by, for example, physically receiving a product or product-related media content. The media content may be provided via printed media and/or computer-readable storage media. Media content may additionally or alternatively be transmitted to a user-held device and/or a user designated correspondence address.

Value added offerings may additionally or alternatively comprise a game or game participation opportunity. The game may be played via printed media, a gaming device, a communication device, and/or a computing device. The game may be played with or without assistance from a customer service representative. Furthermore, a game may be configured to be played by one or more players, depending on a desired implementation.

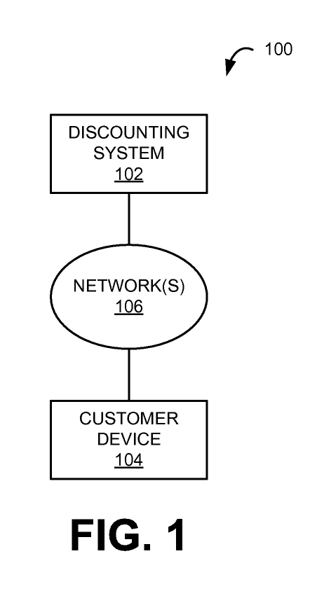

FIG. 1 is a block diagrams illustrating a communication system 100 in accordance with exemplary embodiments. The communication system 100 includes a discounting system 102 that is communicatively coupled to one or more customer devices 104 via one or more networks 106. The discounting system 102 is configured to update discount information for products/services responsive to shopping fees paid by customers. The discounting system 102 may comprise one or more computers such as, for example, desktop computers, laptop computers, and/or servers.

The customer device 104 enables a customer to receive product/service discount information and/or purchase a product/service. The customer device 104 may be located remotely from the discounting system 102 or may alternatively be located in close proximity to the discounting system 102. The customer device 104 may comprise, for example, a desktop computer, a laptop computer, a personal digital assistant (PDA), a television, a television communication terminal, a mobile wireless communication device (e.g., mobile phone), a tablet PC, a remote control device, and/or a landline telephone. The customer device 104 may belong to a corresponding customer or may be made available to the customer by a merchant or vendor when the customer visits a product/service sales location.

Types of networks 106 used for enabling product/service related communications and purchases may include, for example, the Internet, a public switched telephone network (PSTN), a satellite communication network, a cable television network, a local area network (LAN), and/or a mobile wireless communication network. A type of network 106 used may depend on the type of customer device 104 and the location of the customer device 104 relative to the discounting system 102.

Communications used by customers for purchasing a progressively discounted product/service, and/or for requesting and/or receiving discount information may involve various formats and/or protocols depending on the type of customer device 104, communication networks 106, and/or desired implementations. Customer communications may involve, for example, SMS (short messaging system), IVR (intelligent voice recognition), HTTP (hypertext transfer protocol), and/or WAP (wireless application protocol). Customer communications may even involve face to face and/or telephone interaction with a customer service representative.

Product/service information received by a customer computer 102 may comprise textual, graphical, and or audio data, depending on a communication device being used by a customer and/or a desired implementation. For example, a customer browsing products/services via a computer implemented Internet browser may be provided with a textual list of product/service descriptions and prices in addition to corresponding images. As another example, a customer browsing products/services via a landline telephone may be provided with audio product/service information along with audio instructions for browsing and/or purchasing products/services.

Product/service related information may be provided using similar or different combinations of data formats to similar-type devices. For example, some mobile phones may be provided with textual and/or audio information while other mobile phones may be provided with textual and/or graphical information. Information provided to a customer may include instructions that instruct the customer on which buttons or keys to press to browse available products/services, receive desired product/service information, and/or purchase a desired product/service.

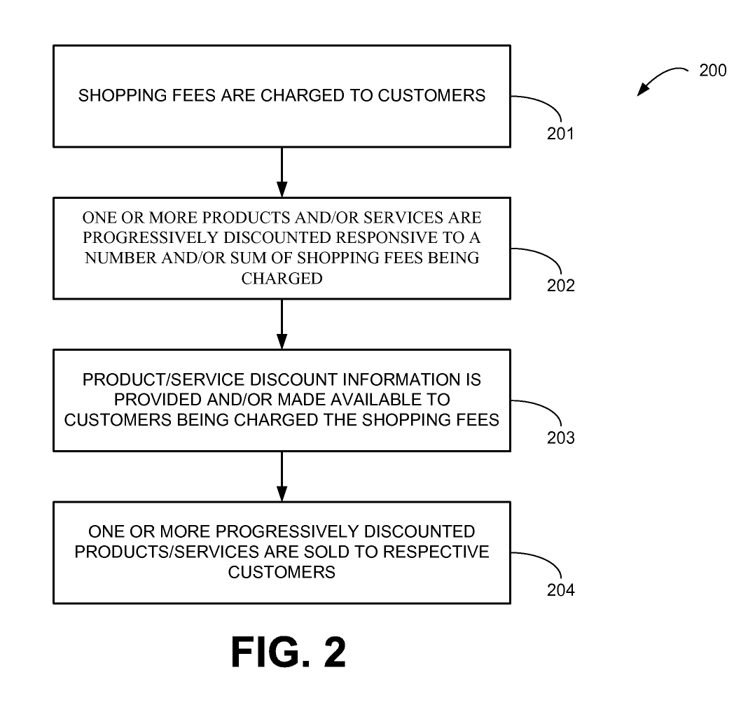

FIG. 2 is a flowchart illustrating a method for progressive discounting in accordance with exemplary embodiments. As indicated in block 201, shopping fees are charged to customers. As discussed above, each shopping fee may comprise and/or may be labeled as, for example, an entry fee, a membership fee, a sale fee, an information access fee, and/or a product access fee. Each charged shopping fee may provide a corresponding customer with access to one or more products/services, groups of products/services, and/or product/service discount information, depending on a desired implementation.

Each fee may provide a customer with one or more purchase opportunities, depending on a desired implementation. A customer may be provided with various fee options or fee structures that have corresponding products/services, product/service groups, discount information, and/or purchase opportunities.

A single or multiple shopping fees may be charged to a customer in connection with a particular product/service or group of products/services. For example, a fee may be charged each time a customer visits a store, each time a customer visits a store section, and/or each time a customer requests to view the discount information of a certain product/service or group of products/services.

A fee may additionally or alternatively be charged for a specified duration or time period for which access to discount information and/or discount purchase privilege is to be provided. For example, by paying a certain fee, a customer may be provided with access to select discounted products/services and prices for, an hour, a day, a week, or a month, depending on a desired implementation.

Shopping fees may be paid via one or more available payment options such as, for example, cash, checks, credit cards, debit cards, stored-value cards, SMS payments, and/or prepaid accounts. SMS payments are also known as premium SMS payments or micro payments. Shopping fees may be paid in substantially in advance and/or just prior to receiving access to corresponding products/services and/or discount information.

One or more products and/or services are progressively discounted responsive to a number and/or sum of shopping fees being charged, as indicated in block 202. A progressive discount may be applied responsive to individual fee payments, responsive to collective numbers or amounts of received fee payments, and/or responsive to numbers or amounts of fee payments during a particular time period. For example, a product may be progressively discounted responsive to: each received fee, a predetermined fee total, and/or a total fee amount received in a current time period (e.g., minute, hour, or day).

Various products/services may be discounted either at similar or different rates. More than one discount basis may be used to implement a combination of discounts. Furthermore, a discount may be applied in a variable and/or non-linear manner. For example, a first discount rate may be initially applied followed by a second discount rate after a certain price, discount, or time interval is reached. As another example, discount amounts may be randomly or pseudo-randomly determined. As yet another example, a discounted amount or rate may become progressively larger or smaller, depending on a desired implementation.

Progressively discounted products/services may be grouped and then discounted responsive to fee payments corresponding to the product/service group. Grouped products/services may alternatively be discounted at different times and/or at different discount rates. For example, products/services in a group of products/services may be discounted on a rotating basis responsive to fee payments. Products/services may be grouped based on one or more product/service characteristics such as, for example, product/service type, name brand, location, and/or price range.

According to exemplary embodiments, products/services may be discounted separately or collectively. For example, products/services throughout a store may be discounted responsive to fees paid by customers entering the store. Additionally or alternatively, products/services within a certain section of a store may be discounted responsive to customers paying fees for browsing such store section. Additionally or alternatively, or a certain product/service may be discounted responsive to a customer paying a fee specifically in connection with such product.

The following tables show non-limiting illustrative examples of types of relationships between shopping fees and product/service discounts. The numerical values in the tables are merely examples being used for illustrative purposes. Different numerical values, currencies, and relationships may additionally or alternatively be used within the scope of the disclosed systems and methods.

TABLE 1
Example showing a fixed discount % per fee payment

| Payment | Discount | Cumulative |
|---|---|---|
| Number | Percentage | Discount % |
| 1 | 0.1 | 0.1 |
| 2 | 0.1 | 0.2 |
| 3 | 0.1 | 0.3 |
| 4 | 0.1 | 0.4 |
| 5 | 0.1 | 0.5 |

TABLE 2
Example showing a fixed discount % per ten fee payments

| Payment | Discount | Cumulative |
|---|---|---|
| Number | Percentage | Discount % |
| 10 | 0.1 | 0.1 |
| 20 | 0.1 | 0.2 |
| 30 | 0.1 | 0.3 |
| 40 | 0.1 | 0.4 |
| 50 | 0.1 | 0.5 |

TABLE 3
Example showing increasing discount % increments

| Payment | Discount | Cumulative |
|---|---|---|
| Number | Percentage | Discount % |
| 1 | 0.1 | 0.1 |
| 2 | 0.2 | 0.3 |
| 3 | 0.3 | 0.6 |
| 4 | 0.4 | 1 |
| 5 | 0.5 | 1.5 |

TABLE 4
Example showing decreasing discount % increments

| Payment | Discount | Cumulative |
|---|---|---|
| Number | Percentage | Discount % |
| 1 | 0.5 | 0.5 |
| 2 | 0.4 | 0.9 |
| 3 | 0.3 | 1.2 |
| 4 | 0.2 | 1.4 |
| 5 | 0.1 | 1.5 |

TABLE 5
Example showing a fixed discount % per received fee amount
Cumulative

| Fees | Discount | Cumulative |
|---|---|---|
| Received | Percentage | Discount |
| $10 | 0.1 | 0.1 |
| $20 | 0.1 | 0.2 |
| $30 | 0.1 | 0.3 |
| $40 | 0.1 | 0.4 |
| $50 | 0.1 | 0.5 |

TABLE 6
Example showing a discount after a certain number of fee payments

| Payment | Discount | Cumulative |
|---|---|---|
| Number | Percentage | Discount % |
| 1 | 0 | 0 |
| 2 | 0 | 0 |
| 3 | 0 | 0 |
| 4 | 0 | 0 |
| 5 | 0.5 | 0.5 |

TABLE 7
Example showing a discount after a certain amount of fee payments

| Fees | Discount | Cumulative |
|---|---|---|
| Received | Percentage | Discount % |
| $10 | 0 | 0 |
| $20 | 0 | 0 |
| $30 | 0 | 0 |
| $40 | 0 | 0 |
| $50 | 0.5 | 0.5 |

TABLE 8
Example showing a fixed discount amount per received fee amount
Cumulative

| Fees | Discount | Cumulative |
|---|---|---|
| Received | Amount | Discount |
| $10 | $5 | $5 |
| $20 | $5 | $10 |
| $30 | $5 | $15 |
| $40 | $5 | $20 |
| $50 | $5 | $25 |

TABLE 9
Example showing products discounted by equal discount percentages

| | First | Second |
|---|---|---|
| Payment | Product | Product |
| Number | Discount % | Discount % |
| 1 | 0.1 | 0.1 |
| 2 | 0.1 | 0.1 |
| 3 | 0.1 | 0.1 |
| 4 | 0.1 | 0.1 |
| 5 | 0.1 | 0.1 |

TABLE 10
Example showing products discounted by different discount percentages

| | First | Second |
|---|---|---|
| Payment | Product | Product |
| Number | Discount % | Discount % |
| 1 | 0.1 | 0.2 |
| 2 | 0.1 | 0.2 |
| 3 | 0.1 | 0.2 |
| 4 | 0.1 | 0.2 |
| 5 | 0.1 | 0.2 |

TABLE 11
Example showing products discounted responsive to different payments

| | First | Second |
|---|---|---|
| Payment | Product | Product |
| Number | Discount % | Discount % |
| 1 | 0.1 | 0 |
| 2 | 0 | 0.1 |
| 3 | 0.1 | 0 |
| 4 | 0 | 0.1 |
| 5 | 0.1 | 0 |

Product/service discount information is provided or made available to customers being charged the shopping fees, as indicated in block 203. As discussed above, the discount information may comprise, for example, a current discount price, discount amount, discount rate, and/or discount percentage. The discount information may, for example, be transmitted by the discounting system 102 to the customer device 104. If a customer is at the location of where a product/service is being sold, then the discount information may be additionally or alternatively be displayed on a display device that is near the corresponding product/service. The discount information may be updated responsive to wired and/or wireless communication signals provided by the discounting system 102.

One or more progressively discounted products/services are then sold to respective customers, as indicated in block 204. A customer might be provided with a limited opportunity to purchase the discounted product/service. For example, a customer may be able to purchase the discounted product/service within a predetermined time window after receiving corresponding discount information or paying a fee. If two or more

The processor 302 is a hardware device for executing software, particularly that stored in memory 304. The processor 302 can be any custom made or commercially available processor, a central processing unit (CPU), an auxiliary processor among several processors associated with the underwriter system, a semiconductor based microprocessor (in the form of a microchip or chip set), or generally any device for executing software instructions.

The memory 304 can include any one or combination of volatile memory elements (e.g., RAM, such as DRAM, SRAM, SDRAM, etc.) and nonvolatile memory elements (e.g., ROM, flash memory, etc.). Moreover, the memory 304 might incorporate electronic, magnetic, optical, and/or other types of storage media. Note that the memory 304 can have a distributed architecture, where various components are situated remote from one another, but can be accessed by the processor 302.

The user I/O device(s) 306 includes input devices such as, for example but not limited to, a keyboard, mouse, scanner, microphone, a touch sensitive display etc. Furthermore, the user I/O device(s) 306 also include output devices such as, for example but not limited to, a printer, display, etc. The network interface device(s) 310 include, for example, a modem, a radio frequency (RF) or other transceiver, a telephonic interface, an Ethernet interface, a bridge, and/or a router.

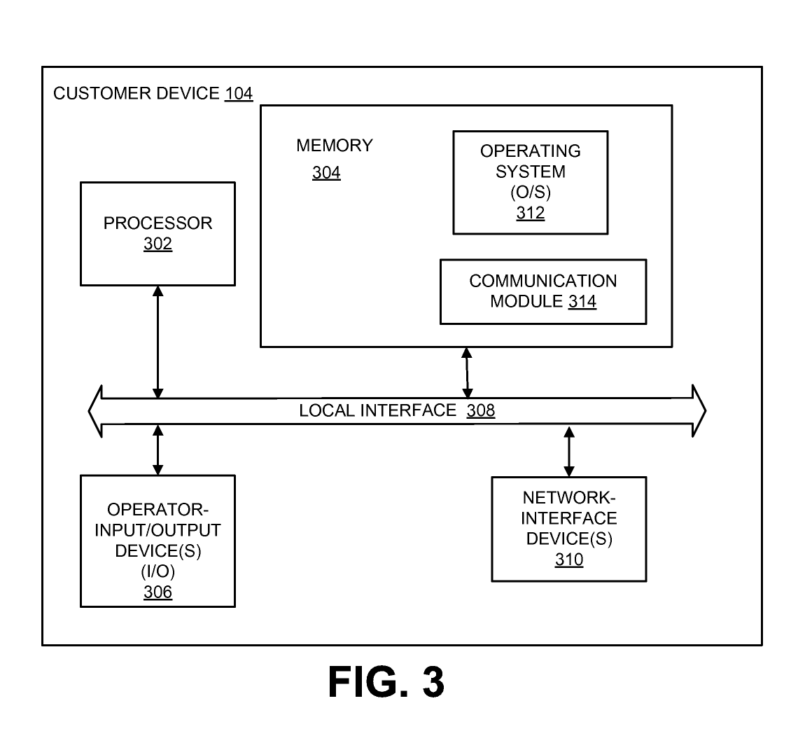

Software stored in memory 304 may include one or more separate programs, each one of which comprises an ordered listing of executable instructions for implementing logical functions. In the example of FIG. 3, the software in the memory 304 includes operating system 312 and a communication module 314. Among other things, the operating system 312 essentially controls the execution of the communication module 314 and provides scheduling, input-output control, file and data management, memory management, and communication control and related services. The communication module 314 is used by a customer to enable the customer device 104 to receive product/service discount information from the discounting system 102 and/or to purchase a progressively discounted product/service.

The communication module 314 may be a source program, executable program (object code), script, or any other entity comprising a set of instructions to be performed. When implemented as a source program, the communication module 314 is translated via a compiler, assembler, interpreter, or the like, which may or may not be included within the memory 304, so as to operate properly in connection with the O/S 312. Furthermore, the communication module 314 can be written in one or more object oriented programming languages, which have classes of data and methods, or procedure programming languages, which have routines, subroutines, and/or functions. In an embodiment, other communication software can be used, depending on a desired implementation.

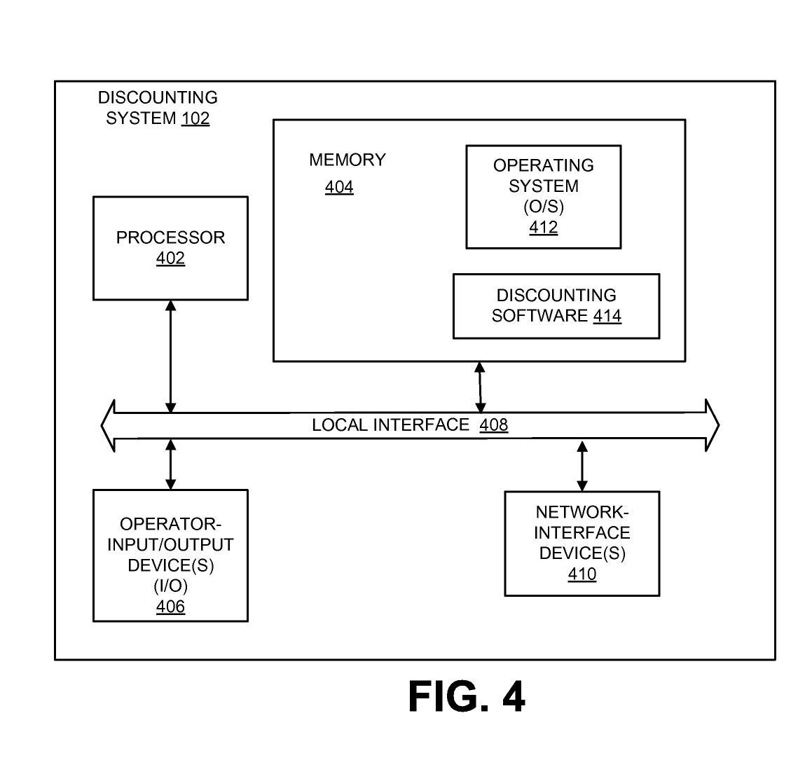

FIG. 4 is a block diagram illustrating a discounting system 102 in accordance with exemplary embodiments. The discounting system 102 includes a processor 402, memory 404, network interface device(s) 410, and one or more user input and/or output (I/O) device(s) 406 (or peripherals) that are communicatively coupled via a local interface 408.

The local interface 408 can be, for example but is not limited to, one or more buses or other wired or wireless connections, as is known in the art. The local interface 408 might have additional elements, which are omitted for simplicity, such as controllers, buffers (caches), drivers, repeaters, and receivers, to enable communications. Further, the local interface 408 might include address, control, and/or data connections to enable appropriate communications among the aforementioned components.

The processor 402 is a hardware device for executing software, particularly that stored in memory 404. The processor 402 can be any custom made or commercially available processor, a central processing unit (CPU), an auxiliary processor among several processors associated with the underwriter system, a semiconductor based microprocessor (in the form of a microchip or chip set), or generally any device for executing software instructions.

The memory 404 can include any one or combination of volatile memory elements (e.g., RAM, such as DRAM, SRAM, SDRAM, etc.) and nonvolatile memory elements (e.g., ROM, flash memory, etc.). Moreover, the memory 404 might incorporate electronic, magnetic, optical, and/or other types of storage media. Note that the memory 404 can have a distributed architecture, where various components are situated remote from one another, but can be accessed by the processor 402.

The user I/O device(s) 406 includes input devices such as, for example but not limited to, a keyboard, mouse, scanner, microphone, a touch sensitive display etc. customers desire to purchase a product, then the customer who is first to provide the required purchase request may be given the right to purchase the product/service over the other customers.

At a physical store location, a customer may provide a purchase request by, for example, pressing a designated button located near the product, by notifying a designated store representative, and/or by providing a designated user input via an electronic device such as, for example, the customer device 104. A customer is charged an amount that comprises the progressively discounted price of a product/service that is purchased by the customer. The discounted purchase price may be paid via one or more available payment options such as, for example, cash, check, credit card, debit card, stored-value card, and/or prepaid account.

A purchased product/service or corresponding voucher may be provided to a customer in any suitable manner depending on the location of the customer, the type of product/service, and/or a desired delivery method. For example, a customer may physically pick-up a product from a designated pick-up location or the product may be mailed or otherwise delivered to a designated customer location. Where appropriate, the product/service or a corresponding voucher may be delivered electronically such as, for example, via e-mail.

FIG. 3 is a block diagram illustrating a customer device 104 in accordance with exemplary embodiments. In the example illustrated in FIG. 3, the customer device 104 comprises a computing device such as, for example, a desktop computer, a laptop computer, a PDA, or a tablet PC. The customer device 104 includes a processor 302, memory 304, network interface device(s) 310, and one or more user input and/or output (I/O) device(s) 306 (or peripherals) that are communicatively coupled via a local interface 308.

The local interface 308 can be, for example but is not limited to, one or more buses or other wired or wireless connections, as is known in the art. The local interface 308 might have additional elements, which are omitted for simplicity, such as controllers, buffers (caches), drivers, repeaters, and receivers, to enable communications. Further, the local interface 308 might include address, control, and/or data connections to enable appropriate communications among the aforementioned components. Furthermore, the user I/O device(s) 406 also include output devices such as, for example but not limited to, a printer, display, etc. The network interface device(s) 410 include, for example, a modem, a radio frequency (RF) or other transceiver, a telephonic interface, an Ethernet interface, a bridge, and/or a router.

Software stored in memory 404 may include one or more separate programs, each one of which comprises an ordered listing of executable instructions for implementing logical functions. In the example of FIG. 4, the software in the memory 404 includes operating system 412 and discounting software 414. Among other things, the operating system 412 essentially controls the execution of the discounting software 414 and provides scheduling, input-output control, file and data management, memory management, and communication control and related services.

The discounting software 414 may be configured to determine a discount for a product/service based on shopping fees paid by customers. The discounting software 414 may also be configured to communicate product/service discount information to customer devices 104. The discounting software 414 may be a source program, executable program (object code), script, or any other entity comprising a set of instructions to be performed. When implemented as a source program, the discounting software 414 is translated via a compiler, assembler, interpreter, or the like, which may or may not be included within the memory 404, so as to operate properly in connection with the O/S 412. Furthermore, the discounting software 414 can be written in one or more object oriented programming languages, which have classes of data and methods, or procedure programming languages, which have routines, subroutines, and/or functions.

While various embodiments of the systems and methods for progressive discounting have been described, it will be apparent to those of ordinary skill in the art that many more embodiments and implementations are possible that are within the scope of this disclosure. Accordingly, the present systems and methods are not to be restricted except in light of the following claims and their equivalents.

What is claimed is:

1. A method comprising:
charging a plurality of fee amounts to a plurality of respective customers at a plurality of different respective times;
progressively reducing a price of at least one item responsive to each of the plurality of fee amounts;
providing each of the respective customers with access to information identifying a current progressively reduced price for the at least one item responsive to charging each of the respective customers a respective fee amount among the plurality of fee amounts; and
selling the at least one item to at least one of the customers at a current progressively reduced price.

2. The method of claim 1, wherein the item comprises at least one of a product and a service.

3. The method of claim 1, wherein the customers are located remotely from the item while the price of the item is being progressively reduced.

4. The method of claim 1, wherein at least one of the customers is located in close proximity to the item while the price of the item is being progressively reduced.

5. The method of claim 1, further comprising progressively reducing prices of a plurality of respective items responsive to each of the plurality of fee amounts.

6. The method of claim 1, wherein each of the fee amounts corresponds to a membership fee.

7. The method of claim 1, wherein the item is sold at a store visited by the customers.

8. The method of claim 1, wherein the item is sold remotely from the locations of the customers.

9. The method of claim 1, wherein the information identifying a current progressively reduced price is transmitted to at least one remotely located customer.

10. The method of claim 1, wherein each of the plurality of fee amounts is charged to a respective customer among the plurality of customers prior to the customer being granted access to an area where the item is located.

11. A system comprising:
a processor; and
memory comprising programming instructions configured to enable the processor to:
progressively reduce a price of at least one item responsive to each of a plurality of fee amounts charge to a plurality of respective customers at a plurality of different respective times; and
provide each of the respective customers with access to information identifying a current progressively reduced price for the at least one item responsive to charging each of the respective customers a respective fee amount among the plurality of fee amounts; and
enable at least one of the customers to purchase the at least one item at a current progressively reduced price.

12. The system of claim 11, wherein the item comprises at least one of a product and a service.

13. The system of claim 11, wherein the customers are located remotely from the item while the price of the item is being progressively reduced.

14. The system of claim 11, wherein at least one of the customers is located in close proximity to the item while the price of the item is being progressively reduced.

15. The system of claim 11, wherein the programming instructions are further configured to enable the processor to progressively reduce prices of a plurality of respective items responsive to each of the plurality of fee amounts.

16. The system of claim 11, wherein each of the fee amounts corresponds to a membership fee.

17. The system of claim 11, wherein the item is sold at a store visited by the customers.

18. The system of claim 11, wherein the item is sold remotely from the locations of the customers.

19. The system of claim 11, wherein the information identifying a current progressively reduced price is transmitted to at least one remotely located customer.

20. The system of claim 11, wherein each of the plurality of fee amounts is charged to a respective customer among the plurality of customers prior to the customer being granted access to an area where the item is located.
